(19) United States
(12) Patent Application Publication
(10) Pub. No.: US 2014/0036505 A1
(43) Pub. Date: Feb. 6, 2014

(54) LED Lighting System

(71) Applicant: Brad Barton, Huntington Beach, CA (US)

(72) Inventor: Brad Barton, Huntington Beach, CA (US)

(73) Assignee: Bartco Lighting, Inc., Huntington Beach, CA (US)

(21) Appl. No.: 13/946,689

(22) Filed: Jul. 19, 2013

Related U.S. Application Data
(60) Provisional application No. 61/677,992, filed on Jul. 31, 2012.

(51) Int. Cl. F21V 21/005

(52) U.S. Cl. CPC F21V 21/005
USPC 362/249.06

(57) ABSTRACT

An LED lamp having electronic components that power a plurality of LEDs arranged on a circuit board contained inside an elongated housing. The LED lamp may include connectors on both ends to allow serial connection of LED lamps through direct connection or use of an extension cord.

### CROSS-REFERENCE TO RELATED APPLICATION

This patent application claims the benefit of U.S. Provisional Patent Application Ser. No. 61/677,992, entitled “LED Lighting System,” filed Jul. 31, 2012, which application is incorporated in its entirety here by this reference.

### TECHNICAL FIELD

This invention relates to a lighting solution that implements light emitting diodes (LEDs) to produce light sufficient for interior or exterior use. The light may function alone or in series with other units.

### BACKGROUND

One of the biggest problems currently facing lighting technology is inefficiency. As technology improves and society presses onward, we, as a culture, have become increasingly more aware of our impact on the environment. Emitting pollutants into the atmosphere has had an undeniable impact on average global temperatures, and while erasing damage that has already occurred is likely an impossible task, it is still possible to mitigate future damage by lowering consumption. By switching to lighting solutions that consume less energy than previous iterations of lighting technologies, modern societies can work toward a more energy efficient future that poses less of a threat to the global environment.

Although fluorescent and now compact fluorescent (CFL) bulbs are more energy efficient alternatives, those bulbs are still subject to limitations that do not affect incandescent bulbs. Fluorescents and CFLs cannot be manually dimmed, and may exhibit noticeable flicker, among other shortcomings. A lighting solution is necessary that combines high efficiency with the advantages of incandescent bulbs.

In the past, incandescent bulbs provided lighting for virtually everything—interior and exterior. Incandescent bulbs function by passing electric current through a filament. The filament acts as an electrical resistor, which then produces heat. Once hot, the filament glows and gives off visible light. One of the problems, however, is that up to 90% of the energy an incandescent bulb dissipates is given off in the form heat and not as visible light. Additionally, incandescent bulbs last typically around 1,000 hours, meaning the bulbs need frequent replacement.

As an alternative to traditional incandescent bulbs, which inventors began to develop in the 1800s, there is the fluorescent bulb. Fluorescent bulb development began in earnest in the 1900s, and the bulbs offered a far more energy efficient solution than incandescent bulbs. Up to around 15% of the energy a fluorescent bulb dissipates is converted into visible light. Additionally, fluorescent bulbs can last up to 10-20 times as long as incandescent bulbs before burning out. On the other hand, fluorescent bulbs are generally long, small diameter tubes—a shape which decreases usefulness in many applications outside of schools, offices, etc.

Recently, compact fluorescent (CFLs) bulbs have become more widely available as an alternative to incandescent bulbs. CFLs operate as fluorescent bulbs, but the tube is typically in a shape that allows a compact form factor. These bulbs are generally similar in size to incandescent bulbs. There are a few drawbacks to this technology, however. Many CFL bulbs take a considerable amount of time to warm up to full function—meaning the bulbs do not give off the maximum amount of light within a fraction of a second of supplying power as incandescent bulbs do. CFLs, as with standard fluorescent bulbs, also contain mercury, and broken bulbs may pose health risks. CFL bulbs also still cost twice that of incandescent equivalents, although that cost is offset over the course of the bulbs lifespan, which is much longer than that of incandescent bulbs. The efficiency of CFL bulbs is still only in the vicinity of about 22%, however, and CFLs typically last in the vicinity of 8,000 hours leaving considerable room for improvement.

The successor to the CFL, which offers solutions to many of the CFL's shortcomings, is the LED driven light. LED lights are created by bringing together many individual LEDs so that they can work in tandem to create light. Unlike fluorescent bulbs, LED lights are dimmable, they have a much longer lifespan at 30,000 hours or more, they do not require any warm up time, and they are mercury-free. LED lights have a theoretical efficiency limit near 44%, and while current LED bulbs generally operate in the vicinity of 12-14% efficiency, significant improvements over both the fluorescent and incandescent bulb are possible.

Therefore, there is a need for a lowered cost, high efficiency light solution that provides all the features many people are accustomed to having with incandescent bulbs, such as dimming and near-instant warm-up time. In addition, the elongated LED lighting solution fills the niche market traditional fluorescent bulbs presently occupy while offering the above described advantages over fluorescent bulbs.

### SUMMARY

The present invention is directed to an LED lighting system in which the electrical components are all contained inside a housing, requiring only a single power cord to provide power to light LEDs. The LED lighting system is much more efficient and versatile than current incandescent, fluorescent lamps, halogen, and other lamps, as the LED lighting system does not require a fixture or a socket. Therefore, the LED lamp can be taken anywhere with a power cord to be plugged in and ready for use. Various fasteners may be provided to secure the LED lighting system to shelves, ceilings, walls, and the like. For example, clips that wrap at least partially around the housing can be secured to a fixed structure and the LED lamp pressed into the clip for a secure fit anywhere.

In the preferred embodiment, the LED lighting system uses a bridge rectifier to generate a DC voltage, which operates a number of LEDs in series. The DC voltage is filtered by electrolytic capacitors, and the non-polar electrolytic capacitors are connected to the line voltage in series with the bridge rectifier input to control the LED current. Resistors are used in series with each string of LEDs, which are connected in parallel across the generated DC voltage source for LED light sources of different lengths. This ensures the light level is equal for different numbers of LEDs in each series string.

### BRIEF DESCRIPTION OF DRAWINGS

FIG. 1 shows a perspective view of the present invention.

FIG. 2 shows a close-up perspective view of the ends of the housing as connected to a power cord and an extension cord of the present invention.

FIG. 3 shows a close-up perspective view of the ends of the housing as connected to a power cord and an end cap of the present invention.

FIG. 4 is a circuit diagram of an embodiment of the present invention.

FIG. 5 is a circuit diagram of an embodiment of the present invention.

FIG. 6 is a front view of a shelving unit with an embodiment of the present invention installed.

FIG. 7 is a side view of another embodiment of a shelving unit with an embodiment of the invention installed.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

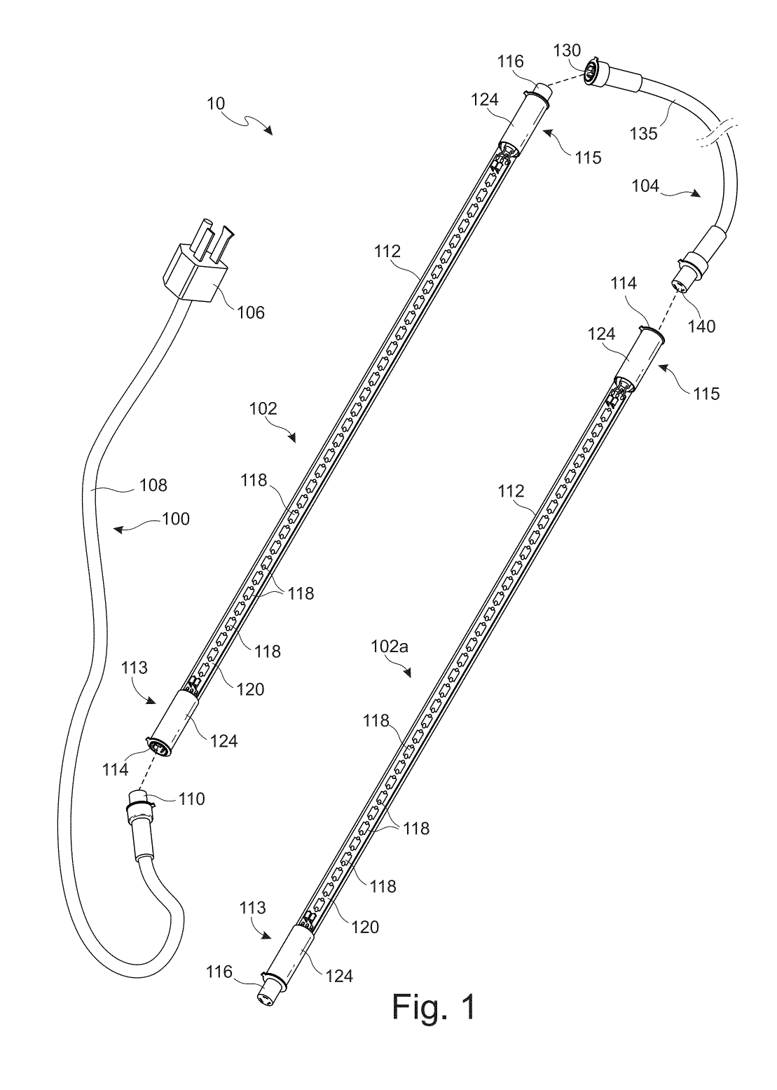

The LED lighting system 10 is a versatile, safe, and efficient lighting system that is easy to use, easy to install, and does not require light sockets. With reference to FIGS. 1-3, the LED lighting system 10 comprises a power cord 100 and an LED lamp 102. Optionally, the LED lighting system 10 may also include an extension cord 104 to attach multiple LED lamps 102, 102a together. In the preferred embodiment, the power cord 100 has a plug 106, such as a three pronged or grounded plug, that connects to a standard wall socket. A flexible cord 108 extends from the plug 106, and terminates at the opposite end of the cord 108 with a connector 110, such as a three-pronged female connection.

The LED lamp 102 of the preferred embodiment comprises a housing 112, two end connectors 114, 116 at opposite ends of the housing 112, a plurality of LEDs 118 contained within the housing 112, and a circuit board 120 configured to hold and drive the LEDs 118. Thus, the circuit board 120 is completely contained within the LED lamp 102, thereby, eliminating the requirement for a light socket.

In the preferred embodiment, the housing 112 is generally a cylindrical tube having a first end 113 and a second end 115 opposite the first end 113. However, the housing 112 can be any other shape, such as circular, ring-like, square, elongated, and the like.

At least a first portion 122 of the housing 112 along a majority of the length of the housing is transparent, translucent, or otherwise made of material having optical qualities that allow for the passage of light. The remaining portions 123 of the housing 112 may be opaque to cover and hide the electronic components 132. In the preferred embodiment, the transparent or translucent portion 122 may be an elongated piece having a semi-circular cross-section. The opaque portion 123 may also be an elongated piece having a semi-circular cross-section configured to mate with the transparent or translucent piece 122. The two semi-circular housing pieces 122, 123 join together to form a hollow cylinder that houses the electronic components 132 with the LEDs 118 facing or adjacent to the translucent portion 122. A pair of cylindrical, hollow sleeves 124 having an inner diameter substantially the same size as the outer diameter of the assembled housing 112 may be used to keep the two portions 122, 123 together by sliding the sleeves 124 over the ends of the housing 112. In some embodiments, the housing 112 may be a single, integral piece.

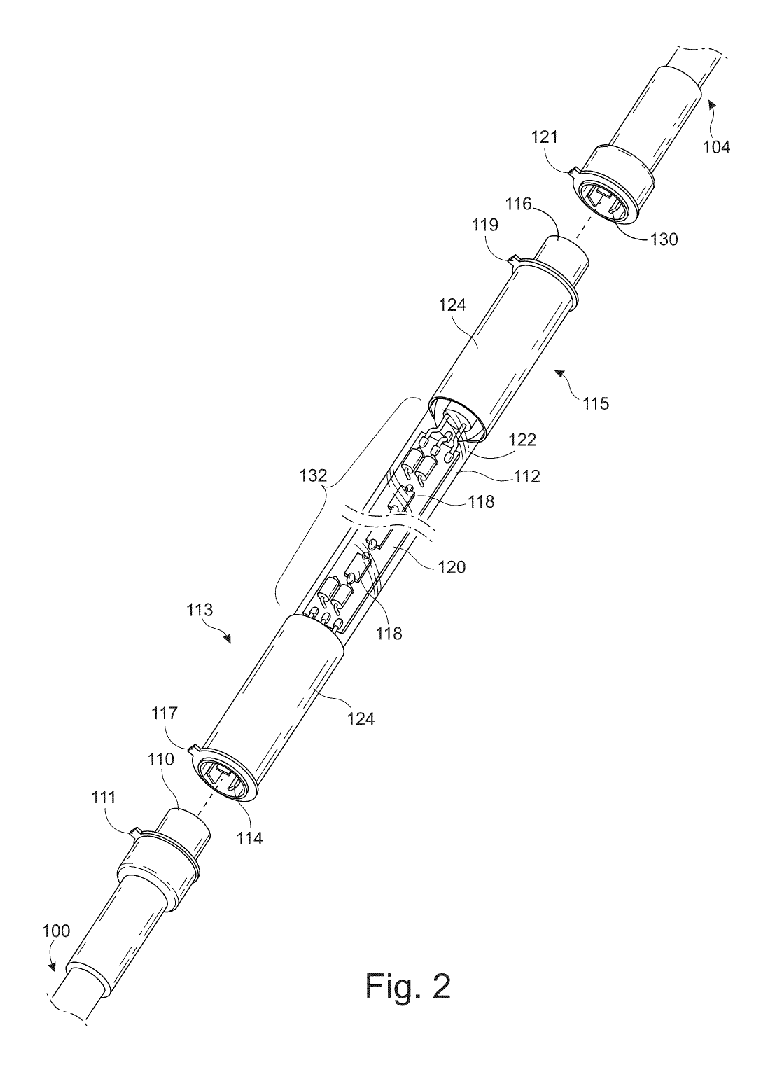

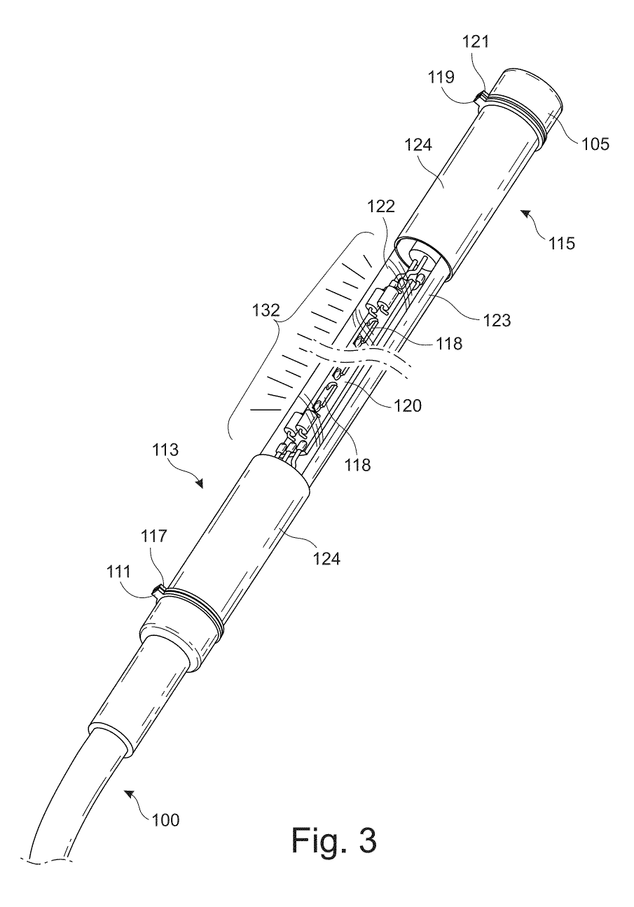

As shown in FIG. 2, the first and second ends 113, 115 of the housing 112 may each have a connector 114, 116 such as a three-pronged male or female connection, that may be pressure fitted into one of the sleeves 124. The connectors 114, 116 are configured to connect with the connector 110 on the power cord 100, another LED lamp 102a, or an extension cord 104. Alignment tabs 111, 117, 119, 121 may be provided on or near the connectors 110, 114, 116, 130 or on the sleeves 124 to aide in properly aligning the respective connector pairs 110, 114 and 116, 130. In some embodiments, one of the ends 115 of the LED lamp 102 might not have another connector, opting instead to implement a cap 105 making the unit a stand-alone device, as shown in FIG. 3.

The circuit components 132—comprised of a circuit board 120 containing a bridge rectifier, various capacitors, LEDs 118, and potentially other IC or electronic components—contained within the LED lamp housing 112 receive alternating current and convert that signal into direct current. Non-polar electrolytic capacitors connected to the line voltage control current going in to a bridge rectifier. The bridge rectifier converts alternating current into direct current. To smooth the voltage signal after the AC current has been converted to DC, an electrolytic capacitor connects the high voltage line with the low voltage line. Direct current passes through resistors, which are used in series with LEDs 118. Those LEDs 118 give off light when dissipating power. With this arrangement, any number of LEDs 118 can be added to change the length of the LED lamp 102. Therefore, the LED lighting system 10 of the present invention can be custom made into any length, shape, and size. This also makes it possible to eliminate the need for a light socket.

Other embodiments of the device might use different colored LEDs. In the preferred embodiment, the LEDs 118 are arranged linearly along the length of the housing 112 directly beneath the translucent portion 122. However, the LEDs 118 may be arranged in different patterns on the printed circuit board 120 to meet different configuration or lighting needs. In some embodiments, a switch may be provided to turn the LEDs on and off. In some embodiments, multiple switches may be provided to select different LEDs to turn on and off. In some embodiments, the switches could be controlled by a controller for automatic or manual control.

In the preferred embodiment, the extension cord 104 comprises a flexible cord 135 with a first connector 130, such as a three-pronged male connector, on one end and a second connector 140, such as a three-pronged female connector, on the other. The first connector 130 of the extension cord 104 connects to the second connector 116 on the second end 115 of the housing 112, and the second connector 140 on the other end of the extension cord 104 can then attach to the first connector 114 on a second LED lamp 102a. This can continue on so that multiple LED lamps 102 can be connected in series.

In some embodiments, the second end 115 of a first LED lamp 102 may be connected to the first end 113 of a second lamp 102a to extend the overall length of the LED lighting system without an extension cord 104.

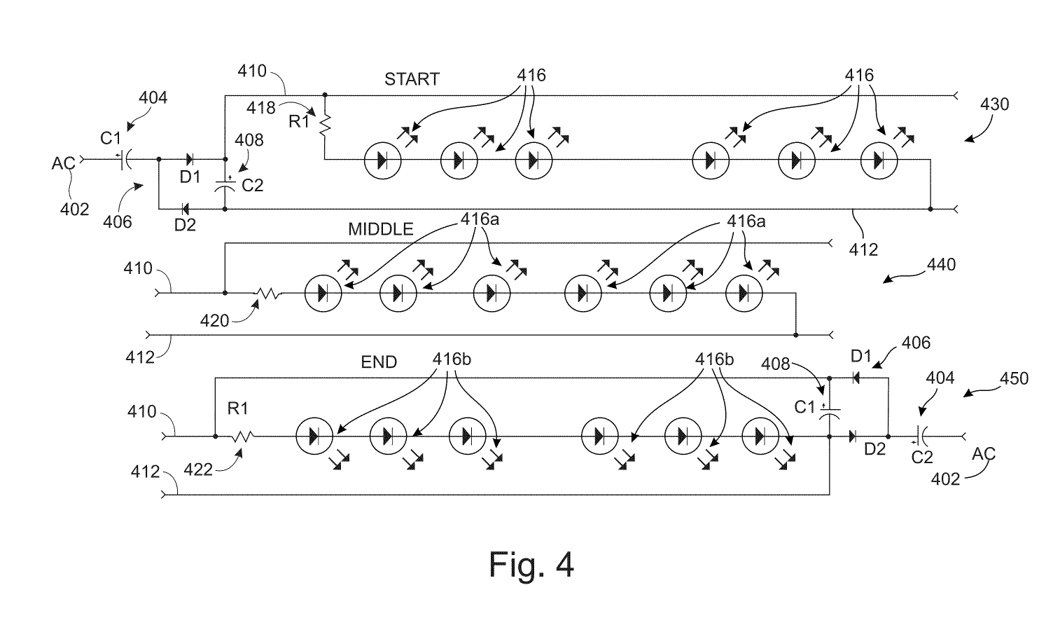

FIG. 4 is an example of a circuit diagram of an embodiment of the integrated circuit in the LED lighting system 10. The power 402 is input from a wall socket into one end of the lamp A non-polarized capacitor 404 (e.g. 10 micro farad) prevents direct current (DC) and allows alternating current (AC) into the circuit. A bridge rectifier 406 directs the current towards the high voltage line 410 to generate a voltage, and prevents current from flowing towards the low voltage line 412 through the use of diodes. To stabilize the voltage, an electrolytic capacitor 408 is set between the high voltage line 410 and the low voltage line 412. The LEDs 416, within a single lamp, are configured in series so they have consistent current running through them. The resistor 418 is used to adjust the resistance so the current is at a correct value for a certain level of brightness in the LED. Multiple lamps with similar circuitry can be connected together.

In FIG. 4, the top circuit 430 is connected in series with the middle circuit 440 so that they share the same high voltage line 410 and low voltage line 412. By way of example only, the top circuit 430 may have forty LEDs 416 in a series. The middle circuit 440 may have 33 LEDs 416a in a series. However, the two sets of LEDs 416, 416a are in a parallel configuration to each other. To make sure the current, which controls the brightness levels, are even, the middle circuit will need more resistance. By way of example only, the top circuit 430 has a resistor 418 with 1 ohm resistance, and the middle circuit 440 has a resistor 420 with a resistance of 220 ohms. The bottom circuit 450 may have forty LEDs 416b, just like the top circuit 430, so the resistor 422 shares the same value as resistor 418 to obtain the same current. The values of resistors, capacitors, and other numbers will change based on the number of LEDs 416, 416a, 416b used, power input, and other information known to persons having ordinary skill in the art.

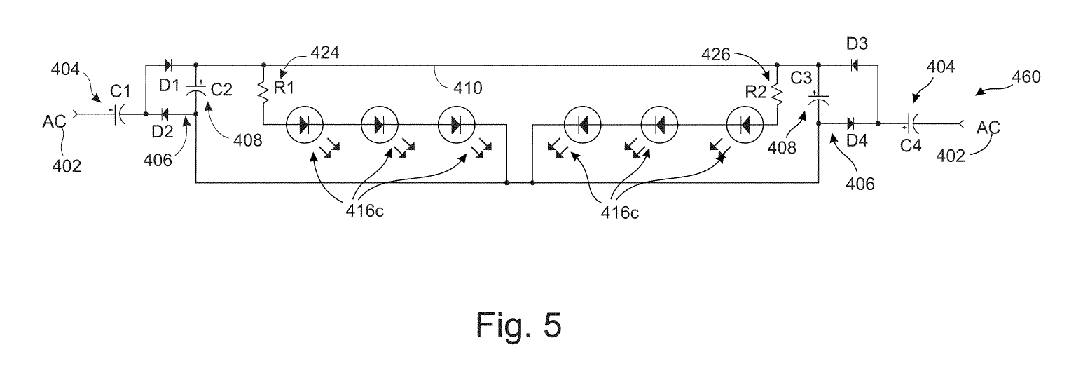

In FIG. 5, another circuit 460 is shown to demonstrate that the LEDs 416c, in a single lamp can be connected in parallel and also that power sources can attach to either end of the LED lamp

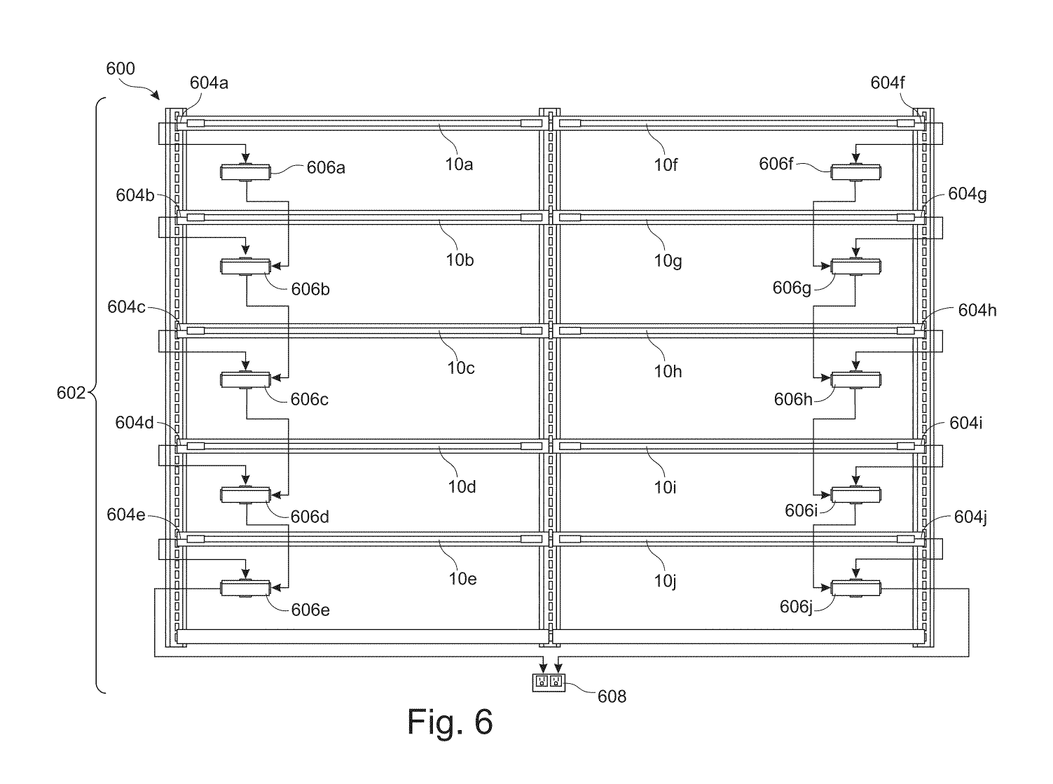

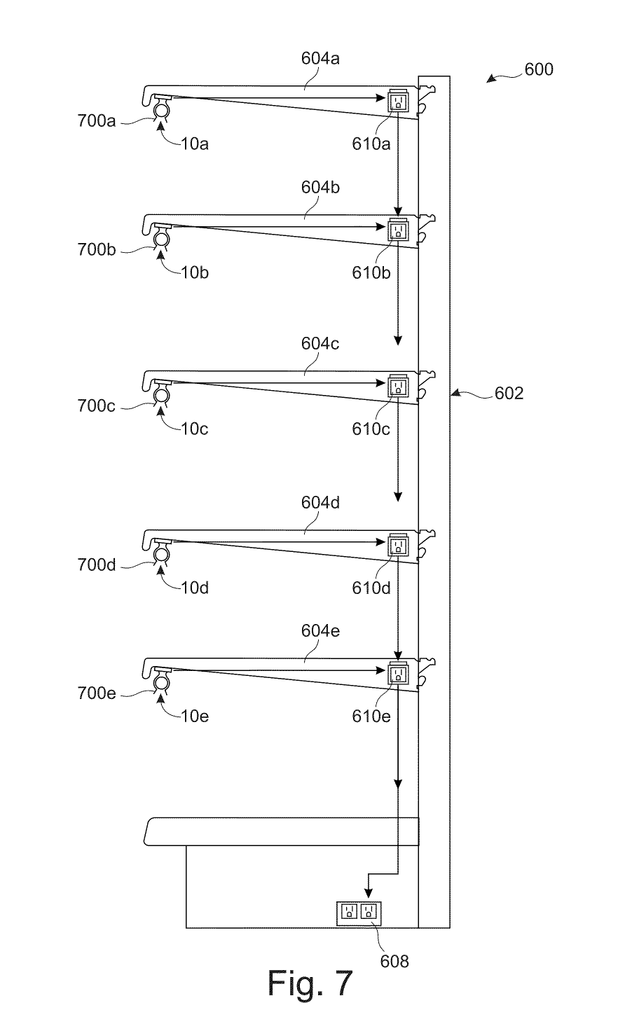

FIGS. 6 and 7 show, by way of example only, a lighted shelving unit system 600 having a shelving unit 602 with a plurality of LED lighting systems 10a-10j installed on each shelf 604a-604j in order to provide light to the area immediately below each LED lighting system 10a-10j. In order to obtain power, each LED lighting system 10a-10j may be plugged into a power distribution box 606a-606j, as in FIG. 6, that may be magnetically attached, or alternatively screwed into or affixed via other means, to each shelf 604a-604j, respectively. The wiring of each power distribution box 606a-606j is plugged into the wiring of a lower power distribution box 606a-606j, and, ultimately, the lowest power distribution box 606e or 606j is plugged into a power supply receptacle 608 inside the base of the shelving unit 602, or alternatively a floor or wall outlet. To illustrate, power distribution box 606a is wired to power distribution box 606b, power distribution box 606b is wired to power distribution box 606c, power distribution box 606c is wired to power distribution box 606d, power distribution box 606d is wired to power distribution box 606e, and power distribution box 606e is wired to power supply receptacle 608. Likewise, power distribution box 606f is wired to power distribution box 606g, power distribution box 606g is wired to power distribution box 606h, power distribution box 606h is wired to power distribution box 606i, power distribution box 606i is wired to power distribution box 606j, and power distribution box 606j is wired to power supply receptacle 608. Each power distribution box 606a-606j may be wired through the inside of the shelving unit 602, and ultimately plugged into a power supply receptacle 608 inside the base of the shelving unit 602, thus allowing for all wires to be hidden from view. Because one power supply receptacle 608 controls power to the entire shelving unit 602 and the plurality of LED lighting systems 10a-10j attached therein, power to each LED lighting system 10a-10j on their respective shelves 604a-604j may be controlled by a single switch. Alternatively, as illustrated in FIG. 7, each shelf 604a-604j may have its own power supply receptacle 610a-610j allowing for each LED lighting system 10a-10j to be directly plugged into a power outlet, thus eliminating the need to hide multiple power cords of varying lengths inside the shelving unit 602 to be out of view, as in FIG. 6. A fastener (only 700a-700e shown) may be attached to each individual shelf 604a-604j in order to fix the LED lighting system 10a-10j to its respective shelf 604a-604j while also allowing the LED lighting system 10a-10j to rotate and adjust for better aiming of light. By way of example only, the fastener 700a-700e may be a clip device, a snap device, a bracket device, a magnetic device, or any other means of fastening the LED lighting system 10a-10j to the shelves 604a-604j.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A light emitting diode (LED) lighting system, comprising:
(a) at least one LED lamp, each LED lamp comprising:
(i) a housing unit having a first end and a second end,
(ii) a first connector attached to the first end of the housing unit and a second connector attached to the second end of the housing unit,
(iii) a plurality of LEDs in the housing unit in between the first and second connectors, and
(iv) a circuit board configured to hold and drive the plurality of LEDs; and
(b) a power cord connectable to the at least one LED lamp

2. The LED lighting system as in claim 1, wherein the housing unit is a cylindrical tube.

3. The LED lighting system as in claim 2, wherein the LED lamp further comprises at least one cylindrical, hollow sleeve, the sleeve having an inner diameter substantially similar to an outer diameter of the housing unit such that the sleeve secures the housing unit.

4. The LED lighting system as in claim 1, wherein the LED lamp further comprises at least one alignment tab on the first connector to properly align the first connector with the power cord.

5. The LED lighting system as in claim 1, wherein the circuit board is completely contained within the housing unit.

6. The LED lighting system as in claim 1, wherein the plurality of LEDs is arranged in a linear array.

7. The LED lighting system in claim 1, wherein a first LED lamp having a first set of LEDs and a second LED lamp having a second set of LEDs are connected in series, and wherein the first set of LEDs and the second set of LEDs are connected in parallel.

8. A light emitting diode (LED) lighting system, comprising:
(a) a plurality of LED lamps, each LED lamp comprising:
(i) a housing unit having a first end and a second end,
(ii) a first connector attached to the first end of the housing unit and a second connector attached to the second end of the housing unit,
(iii) a plurality of LEDs in the housing unit in between the first and second connectors, and
(iv) a circuit board configured to hold and drive the plurality of LEDs;
(b) a power cord connectable to the plurality of LED lamps, and (c) at least one extension cord for connecting the plurality of LED lamps in series.

9. The LED lighting system as in claim 8, wherein the housing unit is a cylindrical tube.

10. The LED lighting system as in claim 9, wherein the LED lamp further comprises at least one cylindrical, hollow sleeve, the sleeve having an inner diameter substantially similar to an outer diameter of the housing unit such that the sleeve secures the housing unit.

11. The LED lighting system as in claim 8, wherein the LED lamp further comprises at least one alignment tab on the first connector to properly align the first connector with the power cord or the extension cord.

12. The LED lighting system as in claim 8, wherein the circuit board is completely contained within the housing unit.

13. The LED lighting system as in claim 8, wherein the plurality of LEDs is arranged in a linear array.

14. The LED lighting system in claim 8, wherein a first LED lamp having a first set of LEDs and a second LED lamp having a second set of LEDs are connected in series, and wherein the first set of LEDs and second set of LEDs are connected in parallel.

15. The LED lighting system as in claim 8, wherein the extension cord comprises a first connector and a second connector, wherein the first connector of the extension cord connects to a second connector of a first LED lamp, and the second connector of the extension cord connects to a first connector of a second LED lamp, thereby connecting the first and second LED lamps in series.

16. A light emitting diode (LED) lighting system, comprising a first LED lamp, the first LED lamp comprising:
(a) a housing unit having a first end and a second end;
(b) a first connector attached to the first end and a second connector attached to the second end;
(c) a first set of LEDs contained in the housing; and
(d) a circuit board configured to hold and drive the first set of LEDs.

17. The LED lighting system as in claim 16, wherein the circuit board comprises a non-polar electrolytic capacitor, a bridge rectifier, and an electrolytic capacitor to generate a stable DC voltage from an AC current.

18. The LED lighting system as in claim 17, further comprising a second LED lamp, wherein the second end of the first LED lamp is connected to a first end of the second LED lamp so that the first set of LEDs in the first LED lamp is connected in parallel to a second set of LEDs in the second LED lamp.

19. The LED lighting system in claim 18, wherein the first set of LEDs has a different number of LEDs than the second set of LEDs, wherein the first set of LEDs is connected in series with a first resistor and the second set of LEDs is connected in series with a second resistor to maintain an equivalent brightness level in each LED.
